(19) United States
(12) Patent Application Publication
(10) Pub. No.: US 2024/0084846 A1
(43) Pub. Date: Mar. 14, 2024

(54) ROLLING BEARING WITH DISTANCE SENSOR

(71) Applicant: AKTIEBOLAGET SKF, GOTEBORG (SE)

(72) Inventor: Franck Landrieve, FONDETTES (FR)

(21) Appl. No.: 18/457,434

(22) Filed: Aug. 29, 2023

(30) Foreign Application Priority Data
Sep. 9, 2022 (DE) 102022209410.7

(51) Int. Cl. F16C 19/38; F16C 41/00

(52) U.S. Cl. CPC F16C 19/381; F16C 41/00; F16C 2233/00; F16C 2300/14

(57) ABSTRACT

A rolling bearing is intended to be mounted on a machine and includes a first ring, a second ring, and at least one row of axial rolling elements and at least one row of radial rolling elements arranged between the two rings. Each of the first and second rings has two frontal faces axially delimiting each ring. At least the first ring is formed as a split ring including a first ring part and a second ring part axially stacked, the first ring part having a frontal face axially bearing against a facing frontal face of the second ring part. At least one first distance sensor is mounted on one of the first and second ring parts of the first ring to measure an axial distance between the frontal faces of the two ring parts.

### CROSS-REFERENCE

This application claims priority to German patent application no. 102022209410.7 filed on Sep. 9, 2022, the entire contents of which are fully incorporated herein by reference.

### BACKGROUND OF THE INVENTION

The present invention relates to the field of rolling bearings, more particularly to large-diameter rolling bearings accommodating axial and radial loads.

Large-diameter bearings for accommodating axial and radial loads are known and typically include an inner ring and an outer ring arranged concentrically about an axis of rotation extending in an axial direction. Such large-diameter rolling bearings may be used, for example, in a tunnel boring machine, in a mining extraction machine or in a wind turbine. More specifically, such large-diameter rolling bearings include two concentric inner and outer rings and at least two rows of rolling elements, such as rollers, arranged between the rings.

Such rolling bearings are generally subjected to high constraints by the structure on which they are assembled by bolts. Bearing assembly procedures specify a high level of assembly surface geometry quality and conformance to bolt tensioning specifications in such a way the bearing geometry can be maintained within specification during machine operation. Because of vibrations and variable constraints, the bolts may become loose over time. It can also happen that constraints or loading may be higher than what the specified bolt and tensioning can support.

Thus, under certain operating conditions, this may lead to high bearing deformation causing high degree of wear and bearing destruction. As such, it is common to anticipate the need for periodic inspection to monitor the bolt tensioning.

### SUMMARY OF THE INVENTION

One aim of the present invention is to overcome the drawback of requiring inspections to monitor bolt tensioning.

The present invention relates to a rolling bearing intended to be mounted on a machine and comprising a first ring, a second ring, at least one row of axial rolling elements arranged between radial raceways provided on the rings, and at least one row of radial rolling elements arranged between axial raceways provided on the rings. The second ring includes a protruding nose or shoulder engaged into an annular groove of the first ring and provided with the axial raceway and with the radial raceway of the second ring. Further, at least the first ring is formed as a split ring and includes a first ring part and a second ring part axially stacked, the first ring part comprising a frontal face axially bearing against a facing frontal face of the second ring part.

According to a general feature of the present invention, the rolling bearing further comprises at least one first distance sensor mounted on one of the first and second ring parts of the first ring to measure the axial distance between the frontal faces of the ring parts. The terms “axial rolling elements” is understood to mean rolling elements adapted to accommodate axial loads whereas the terms “radial rolling elements” is understood to mean rolling elements adapted to accommodate radial loads.

Due to the present invention, the tensioning of the bolts used to assemble the first ring on the machine can be monitored by means of a loss of axial contact between the frontal faces of the ring parts. One ring part of the first ring may include a radial hole axially opening onto the frontal face and inside which is disposed the first distance sensor. The sensing face of the first distance sensor may be flush with the frontal face of the ring part.

Preferably, the rolling bearing further comprises a control unit connected to the first distance sensor and adapted to trigger an alarm when the value of the axial distance detected by the first distance sensor is higher than a first predetermined threshold. The control unit may be located remote from the components of the rolling bearing. Alternatively, the control unit may be mounted on one of the components of the rolling bearing, for example, on the first ring or on the second ring.

In one embodiment, the rolling bearing comprises a plurality of first distance sensors spaced apart in the circumferential direction, notably regularly or evenly spaced.

Preferably, the rolling bearing further comprises at least one second distance sensor mounted on one of the first and second rings and provided with a sensing face oriented axially outwardly to measure the axial distance between one of the frontal faces of the one ring and a first assembly surface of the machine intended to axially face the frontal face of the one ring. Accordingly, the tensioning of the bolts used to assemble the rolling bearing on the first assembly surface of the machine can be monitored by sensing the loss of axial contact between the frontal face of the ring and the first assembly surface.

The one ring with the second sensor may include a radial hole axially opening onto the frontal face and inside of which is disposed the second distance sensor. The sensing face of the second distance sensor may be flush with the frontal face of the other ring. Preferably, the second distance sensor is connected to the control unit, which is further adapted to trigger an alarm when the value of the axial distance detected by the second distance sensor is higher than a second predetermined threshold. In one embodiment, the rolling bearing comprises a plurality of second distance sensors spaced apart in the circumferential direction, preferably regularly or evenly.

In one embodiment, the rolling bearing further comprises at least one third distance sensor mounted on the other one of the first and second rings, i.e., the ring not including one or more of the second sensors, and provided with a sensing face oriented axially outwardly to measure the axial distance between the frontal face of the other ring, which is axially on the side opposite to the frontal face of the ring, and a second assembly surface of the machine intended to axially face the frontal face of the other ring.

Accordingly, the tensioning of the bolts used to assemble the rolling bearing on the second assembly surface of the machine can be monitored.

Preferably, the third distance sensor is connected to the control unit, which is further adapted to trigger an alarm when the value of the axial distance detected by the third distance sensor is higher than a third predetermined threshold.

The other one of the first and second rings may include a radial hole axially opening onto the frontal face of the other ring and inside of which is disposed the third distance sensor. The sensing face of the third distance sensor may be flush with the frontal face of the other ring. In one embodiment, the rolling bearing comprises a plurality of the third distance sensors spaced apart in the circumferential direction, preferably regularly or evenly.

In one embodiment, the rolling bearing comprises at least two rows of axial rolling elements each arranged between radial raceways provided on the rings, the two rows of axial rolling elements being disposed axially on each side of the nose of the second ring. In other words, one row of axial rolling elements is disposed on one side of the nose of the second ring and the other row of axial rolling elements is disposed on the other, opposing side of the second ring nose.

### BRIEF DESCRIPTION OF THE SEVERAL VIEWS OF THE DRAWINGS

The present invention and its advantages will be better understood by studying the detailed description of a specific embodiment given by way of a non-limiting example and illustrated by the appended drawings on which:

FIG. 1 is a partial cross-section of a rolling bearing according to an example of the invention; and

FIG. 2 is another partial cross-section of the rolling bearing of FIG. 1.

### DETAILED DESCRIPTION OF THE INVENTION

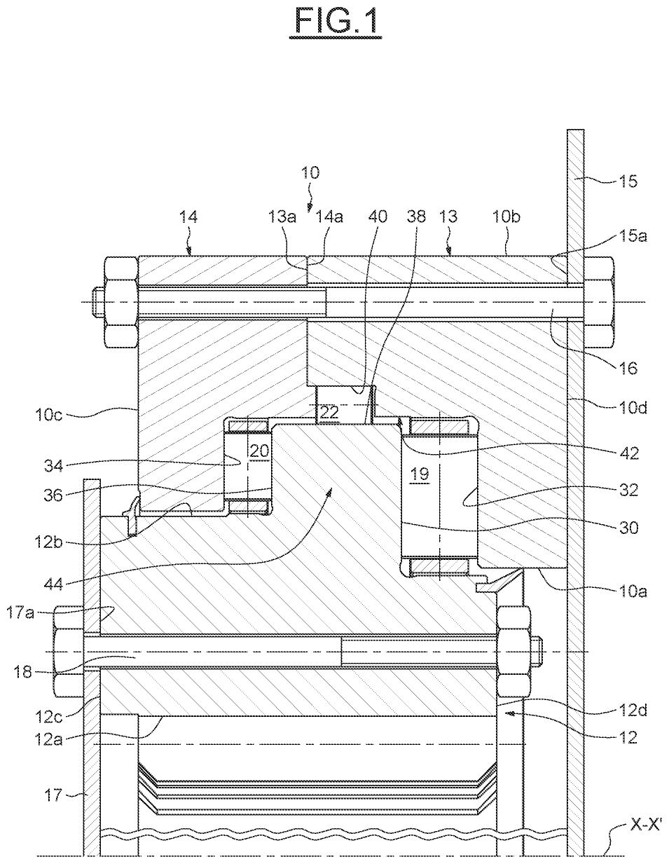

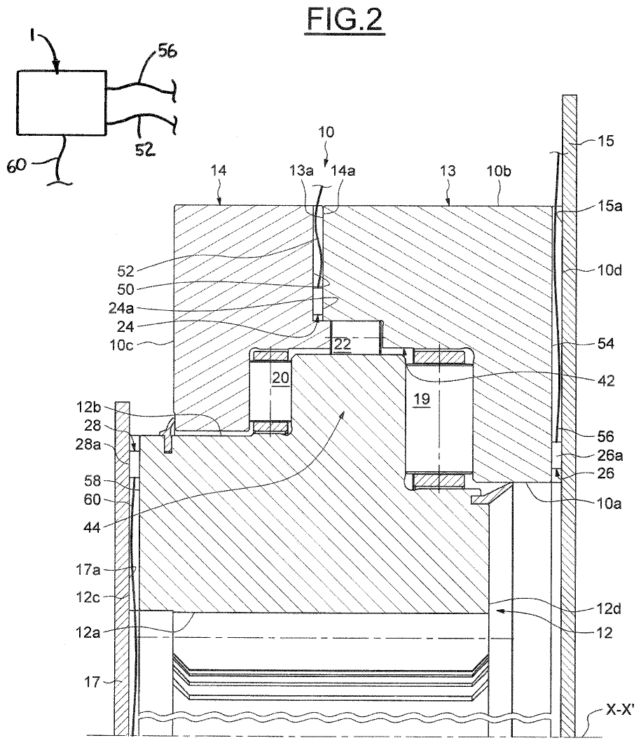

The rolling bearing as illustrated on FIGS. 1 and 2 is a large-diameter rolling bearing comprising a first ring 10 and a second ring 12. In the illustrated example, the first ring 10 is the outer ring whereas the second ring 12 is the inner ring. The rolling bearing may, for example, be used in a machine, such as tunnel boring machine, a wind turbine or any other machines using a large diameter rolling bearing.

The outer and inner rings 10, 12 are concentric and extend axially along the bearing rotation axis X-X′ which runs in an axial direction. In this illustrated example, the rings 10, 12 are of the solid type.

The outer ring 10 is formed as a split ring and comprises a first ring part 13 and a second ring part 14 stacked one relative to the other in the axial direction. The ring parts 13, 14 are provided with a plurality of aligned axial through-holes (not indicated) which each receive a bolt 16 that joins together the ring parts 13, 14 and assembles or attaches the outer ring 10 to a first part 15 of the structure of the associated machine.

The inner ring 12 is also provided with a plurality of axial through-holes (not indicated) which each receive a bolt 18 that assembles or attaches the inner ring 10 to a second part 17 of the associated machine. The first and second parts 15, 17 of the machine are axially disposed on each side of the rolling bearing. That is, the first machine part 15 is disposed on one axial side of the rolling bearing and the second machine part 17 is disposed on the other axial side of the rolling bearing.

In the illustrated example, the rolling bearing comprises two rows of axial rollers 19, 20 which are arranged between the outer and inner rings 10, 12 in order to form an axial thrust or support axial loading, and a single row of radial rollers 22 which are arranged between the rings 10, 12 to form a radial thrust or support radial loading.

As will be described in further detail below, the rolling bearing also comprises one or more first distance sensors 24 for detecting the axial distance between the first ring part 13 and the second ring part 14 of the outer ring 10. In the illustrated example, the rolling bearing further comprises one or more second distance sensors 26 for detecting the axial distance between the outer ring 10 and the first part 15 of the machine and one or more third distance sensors 28 for detecting the axial distance between the inner ring 12 and the second part 17 of the machine.

The rollers 19, 20, 22 of each row are identical to each other. The axis of rotation of each roller 22 is parallel to the axis X-X′ of the bearing and perpendicular to the axes of rotation of each of the rollers 19, 20. In the illustrated example, the axial length of each roller 19 is larger or greater than the axial length of each one of the rollers 20. Alternatively, the axial length of the rollers 19 may be smaller/lesser than, or may be equal to, the axial length of each one of the rollers 20. Alternatively, the row of rollers 19 may be replaced by two rows of superimposed rollers.

The axial rollers 19 are arranged axially between annular radial raceways 30, 32 respectively formed on the inner and outer rings 12, 10. That is, the radial raceway 30 is formed on the inner ring 12 and the radial raceway 32 is formed on the outer ring 10. The raceways 30, 32 face each other in the axial direction. The rolling surface of each axial roller 19 is in axial contact with each one of the raceways 30, 32.

The axial rollers 20 are arranged axially between annular radial raceways 34, 36 respectively formed on the inner and outer rings 12, 10. In other words, the radial raceway 34 is formed on the outer ring 10 and the radial raceway 36 is formed on the inner ring 12. The raceways 34, 36 axially face each other. The rolling surface of each axial roller 20 is in axial contact with each one of the raceways 34, 36. The two rows of axial rollers 19, 20 are spaced apart from each other in the axial direction.

The radial rollers 22 are arranged radially between annular axial raceways 38, 40 respectively formed on the inner and outer rings 12, 10. Specifically, the radial rollers 22 are disposed between an annular axial raceway 38 formed on the inner ring 12 and an annular axial raceway 40 formed on the outer ring 10. The two raceways 38, 40 face each other in the radial direction. The row of radial rollers 22 is radially offset outwards with respect to the rows of axial rollers 19, 20. The rolling surface of each one of the radial rollers 22 is in radial contact with each one of the raceways 38, 40. The row of radial rollers 22 is located axially between the two rows of axial rollers 19, 20.

The outer ring 10 includes an annular groove 42 opening in a radial direction inwardly toward the inner ring 12. The outer ring 10 includes an inner stepped cylindrical bore 10a from which the groove 42 is formed. The outer ring 10 also includes an outer cylindrical surface 10b which is radially opposite to the bore 10a. The outer ring 10 further comprises two opposite radial or radially-extending frontal faces 10c, 10d which axially delimit the inner bore 10a and the outer surface 10b of the ring 10. The frontal faces 10c, 10d also axially delimit the outer ring 10. As such, the frontal faces 10c, 10d axially delimit the thickness of the outer ring 10.

As previously mentioned, the outer ring 10 is divided in the axial direction in two separate parts, specifically the ring part 13 and the ring part 14. The two ring parts 13, 14 together delimit the groove 42. The radial raceway 32 is located on the ring part 13 and the radial raceway 36 is located on the ring part 14 of the outer ring 10. The frontal face 10d is located on the ring part 13 and the frontal face 10c is located on the ring part 14.

The ring part 13 and the second ring part 14 are stacked relative to each other in the axial direction. The first ring part 13 includes a frontal face 13a axially bearing against a facing frontal face 14a of the ring part 14.

The inner ring 12 comprises an annular shoulder or protruding nose 44 engaging into the annular groove 42 of the outer ring 10. The nose 44 extends or projects radially outwardly from a remainder of the inner ring 12.

The two rows of axial rollers 19, 20 are arranged axially between the nose 44 of the inner ring 12 and the groove 42 of the outer ring 10. The two rows of axial rollers 19, 20 are disposed on each side of the nose 44; that is, the row of axial rollers 19 are disposed on one side of the nose 44 and the row of axial rollers 20 are disposed on the other side of the nose 44. The radial raceways 30, 36 are each located on the nose 44. The radial raceways 32, 34 are each located on the groove 42.

The row of radial rollers 22 is arranged radially between the nose 44 of the inner ring 12 and the groove 42 of the outer ring 10. The axial raceways 38, 40 are respectively located on the nose 44 and the groove 42; that is, the axial raceway 38 is located on the nose 44 and the axial raceway 40 is located on the groove 42.

In the illustrated example, the inner ring 12 is made in one part; i.e., the inner ring 12 is of one piece construction. Alternatively, the inner ring 12 may be divided in the axial direction in at least two separate parts that are secured together. In another variant, the nose 44 may be formed separately from the main part or remainder of the inner ring 12 and attached thereto by any appropriate means (e.g., by fasteners, welding, etc.).

The inner ring 12 includes an inner cylindrical bore 12a and a stepped outer cylindrical surface 12b which is radially opposite to the bore 12a. In the illustrated example, the bore 12a of the inner ring 12 is provided with a gear teeth (not referenced). The inner ring 12 further comprises two opposite radial frontal faces 12c, 12d which axially delimit the bore 12a and the outer cylindrical surface 12b. The frontal faces 12c, 12d also axially delimit the inner ring 12. Thus, the frontal faces 12c, 12d also axially delimit the thickness of the inner ring 12. The protruding nose 44 protrudes or projects radially outwardly from the outer cylindrical surface 12b.

The second part 17 of the machine axially abuts against the frontal face 12c of the inner ring 12 whereas the first part 15 axially abuts against the frontal face 10d of the outer ring 10. The second part 17 has an assembly surface 17a axially bearing against the frontal face 12c and the first part 15 has an assembly surface 15a axially bearing against the frontal face 10d in normal use of the bearing.

As previously mentioned, the one or more first distance sensors 24 are provided to measure the axial distance between the first part 13 and the second part 14 of the outer ring 10. In FIG. 2, only one of the first distance sensors 24 is shown. The distance sensors 24 are spaced apart in the circumferential direction, preferably regularly or evenly. For example, four distance sensors 24 located every 90° may be provided. Alternatively, a different number and/or arrangement of distance sensors 24 may be foreseen. In another variant, only one distance sensor 24 is provided.

Each distance sensor 24 is provided to measure the axial distance between the frontal face 13a of the first ring part 13 of the outer ring 10 and the frontal face 14a of the second ring part 14 of the outer ring 10. Each distance sensor 24 has a sensing face 24a oriented axially towards the frontal face 13a of the first ring part 13. That is, the sensor sensing face 24a axially faces the ring part frontal face 13a. Preferably, the sensing face 24a is axially flush with the frontal face 13a of the first ring part 13. Alternatively, the sensing face 24a may be axially offset with respect to the ring part frontal face 13a.

The second ring part 14 of the outer ring 10 is provided with a plurality of first radial holes 50, one of the first distance sensors 24 being located within each one of the first radial holes 50. Each hole 50 axially faces the frontal face 13a of the first ring part 13. Preferably, the shape of each hole 50 is complementary to that of the associated distance sensor 24. Each distance sensor 24 is secured inside the associated hole 50 by any appropriate means, for example by force-fitting. Further, each distance sensor 24 has a longitudinal axis (not indicated) extending radially and perpendicular to the axis X-X′ of the rolling bearing.

In the disclosed example, each distance sensor 24 also comprises an output connecting cable 52 for transmitting sensing data which extends outwardly from the associated hole 50. Specifically, the output cable 52 extends radially outwardly. The output cable 52 connects the associated distance sensor 24 to the control unit 1 of the rolling bearing so as to transmit distance measurements. Alternatively, the sensors 24 may be formed without any output cable, for example, when each sensor 24 is a wireless sensor.

In the disclosed example, the distance sensors 24 are provided on the second ring part 14 of the outer ring 10. Alternatively, the distance sensors 24 may be provided on the first ring part 13 of the outer ring 10, in which case the sensing face 24a of each distance sensor 24 axially faces the frontal face 14a of the second ring part 14.

Each sensor 24 may be an inductive distance sensor, inductive proximity switch, an ultrasonic distance sensor, or an optical distance sensor. Alternatively, each sensor 24 may be a mechanical distance sensor provided with a contact stylus. In such a case, the mechanical sensor faces the frontal face 13a of the first ring part 13 and also contacts the frontal face 13a.

As previously mentioned, one or more second distance sensors 26 may be provided to measure the axial distance between the outer ring 10 and the first part 15 of the machine. In FIG. 2, only one of the second distance sensors 26 is shown. The second distance sensors 26 are spaced apart in the circumferential direction, preferably regularly or evenly. For example, four distance sensors 26 may be placed every 90° apart on the outer ring 10. Alternatively, a different number and/or arrangement of distance sensors 26 may be foreseen. In another variant, only one distance sensor 26 is provided.

Each distance sensor 26 is provided to measure the axial distance between the frontal face 10d of the outer ring 10 and the assembly surface 15a of the first part of the machine which axially faces the frontal face 10d.

Each distance sensor 26 is provided with a sensing face 26a oriented axially outward towards the assembly surface 15a of the first part of the machine. The sensing face 26a axially faces the assembly surface 15a. Preferably, the sensing face 26a is axially flush with the frontal face 10d of the outer ring 10. Alternatively, the sensing face 26a may be axially offset inwardly with respect to the frontal face 10d.

The outer ring 10 is provided with a plurality of second radial holes 54 inside each of which one of the second distance sensors 26 is located. Each hole 54 extends from the outer surface 10b of the outer ring 10 and opens on the bore 10a. Each hole 54 also opens on the frontal face 10d and axially faces the assembly surface 15a of the first part 15 of the machine. Preferably, the shape of each hole 54 is complementary to that of the associated distance sensor 26. Each distance sensor 26 is secured inside the associated hole 54 by any appropriate means, for example by force-fitting or friction. Further, each distance sensor 26 has a longitudinal axis (not referenced) extending radially and perpendicular to the axis X-X′ of the rolling bearing.

In the disclosed example, each distance sensor 26 also comprises an output connecting cable 56 for transmitting sensing data which extends outwardly from the associated hole 54. The output cable 56 extends radially outwardly and connects the associated distance sensor 26 to the control unit 1 of the rolling bearing so as to transmit measured distances. Alternatively, the sensors 26 may be formed without any such output cable, for example when each sensor 26 is a wireless sensor.

Each sensor 26 may be an inductive distance sensor, an inductive proximity switch, an ultrasonic distance sensor, or an optical distance sensor. Alternatively, each sensor 26 may be a mechanical distance sensor provided with a contact stylus. In such a case, the mechanical sensor faces the assembly surface 15a of the first part 15 of the machine and also contacts the assembly surface 15a.

As further mentioned above, one or more third distance sensors 28 may be provided to measure the axial distance between the inner ring 12 and the second part 17 of the machine. In FIG. 2, only one of the third distance sensors 28 is shown. The distance sensors 28 are spaced apart in the circumferential direction, preferably regularly or evenly. For example, four distance sensors 28 may be provided at every 90° about the inner ring 12. Alternatively, a different number and/or arrangement of distance sensors 28 may be provided. In another variant, only one distance sensor 28 is provided.

Each distance sensor 28 is provided to measure the axial distance between the frontal face 12c of the inner ring 12 and the assembly surface 17a of the second part 17 of the machine which axially faces the frontal face 12c. Each distance sensor 28 is provided with a sensing face 28a oriented axially outward towards the assembly surface 17a of the second part 17 of the machine. Specifically, the sensing face 28a axially faces the assembly surface 17a. Preferably, the sensing face 28a is axially flush with the frontal face 12c of the inner ring 12. Alternatively, the sensing face 28a may be offset axially inwardly with respect to the frontal face 12c.

Preferably, the inner ring 12 is provided with a plurality of third radial holes 58 and each of the third distance sensors 28 is located within a separate one of the radial holes 58. Each hole 58 extends inwardly from the outer surface 12b of the inner ring 12 and opens on the bore 12a. Each hole 58 also opens on the frontal face 12c and axially faces the assembly surface 17a of the second part 17 of the machine. Preferably, the shape of each hole 58 is complementary to that of the associated distance sensor 28. Each distance sensor 28 is secured inside the associated hole 58 by any appropriate means, for example by force-fitting or friction. Further, each distance sensor 28 has a longitudinal axis (not referenced) extending radially and perpendicular to the axis X-X′ of the rolling bearing.

In the disclosed example, each distance sensor 28 also comprises an output connecting cable 60 for transmitting sensing data which extends radially inwardly from the hole 58. The output cable 60 connects the associated distance sensor 28 to the control unit 1 of the rolling bearing so as to transmit distance measurements. Alternatively, the third sensors 28 may be formed without any output cable when the sensors 28 are wireless.

Each sensor 28 may be an inductive distance sensor, inductive proximity switch, an ultrasonic distance sensor, or an optical distance sensor. Alternatively, each sensor 28 may be a mechanical distance sensor provided with a contact stylus. In such a case, the mechanical sensor faces the assembly surface 17a of the second part 17 of the machine and also contacts the assembly surface.

The first distance sensors 24 allow measurements and continuous monitoring of the axial distance between the frontal faces 13a, 14a of the outer ring 10. The first distance sensors 24 also allow tension monitoring of the bolts 16. When the value of this distance exceeds a first predetermined threshold, the control unit 1 of the bearing preferably triggers an alarm.

The second distance sensors 26 allow measurements and continuous monitoring of the axial distance between the frontal face 10d of the outer ring 10 and the assembly surface 15a of the first part 15 of the machine. The distance sensors 26 thereby allow tension monitoring of the bolts 16. When the value of this distance exceeds a second predetermined threshold, the control unit 1 of the bearing triggers an alarm. The second predetermined threshold may be equal or different from the first predetermined threshold.

Further, the third distance sensors 28 allow measurements and continuous monitoring of the axial distance between the frontal face 12c of the inner ring 12 and the assembly surface 17a of the second part 17 of the machine. The distance sensors 28 allow tension monitoring of the bolts 18. When the value of this distance exceeds a third predetermined threshold, the control unit 1 of the bearing triggers an alarm. The third predetermined threshold may be equal or different from the first and second predetermined thresholds.

In the illustrated example, the rolling bearing is provided with each one of the first, second and third distance sensors 24, 26 and 28. Alternatively, the rolling bearing may be provided only with the first distance sensor(s) 24. In another variant, the rolling bearing may be provided with one or more first distance sensors 24 and with either the second distance sensor(s) 26 or with the third distance sensor(s) 28.

Otherwise, as previously mentioned, in this illustrated example, the first ring 10 of the rolling bearing is the outer ring 10 whereas the second ring is the inner ring 12. As an alternative, it could be possible to provide a reversed arrangement with the first ring forming the inner ring and the second ring forming the outer ring. In this case, the groove formed on the inner ring opens radially outwardly and the nose of the outer ring extends radially inwardly.

In the described examples, the rolling bearing is provided with a rolling bearing comprising three rows of rolling elements. Alternatively, the rolling bearing may comprise only two rows of rolling elements, or four or more rows of rolling elements. In the illustrated example, the rolling elements are rollers. The rolling bearing may comprise other types of rolling elements, for example balls.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A rolling bearing intended to be mounted on a machine, the rolling bearing comprising:
a first ring formed as a split ring including a first ring part and a second ring part, the first and second ring parts being axially stacked, the first ring part having a frontal face axially bearing against a facing frontal face of the second ring part, the first ring having an annular groove, a radial raceway and an axial raceway;
a second ring having a protruding nose engaged into the annular groove of the first ring, the nose having a radial raceway and an axial raceway;
at least one row of axial rolling elements arranged between the radial raceway of the first ring and the radial raceway of the second ring;
at least one row of radial rolling elements arranged between the axial raceway of the first ring and the axial raceway of the second ring; and
at least one first distance sensor mounted on one of the first and second ring parts of the first ring to measure an axial distance between the frontal faces of the first and second ring parts.

2. The rolling bearing according to claim 1, wherein one of the first and second ring parts of the first ring has a radial hole axially opening onto the frontal face of the one ring part, the at least one first distance sensor being disposed within the radial hole.

3. The rolling bearing according to claim 2, wherein the sensing face of the first distance sensor is flush with the frontal face of the one ring part.

4. The rolling bearing according to claim 1, further comprising a control unit connected to the first distance sensor and adapted to trigger an alarm when a value of the axial distance detected by the first distance sensor is greater than a first predetermined threshold.

5. The rolling bearing according to claim 1, further comprising at least one second distance sensor mounted on one of the first and second rings and provided with a sensing face oriented axially outwardly to measure an axial distance between one of the frontal faces of the one of the first and second rings and a first assembly surface of the machine axially facing the frontal face of the one ring.

6. The rolling bearing according to claim 5, wherein the one of the first and second rings includes a radial hole axially opening onto the frontal face of the one ring, the second distance sensor being disposed inside the radial hole.

7. The rolling bearing according to claim 6, wherein the second distance sensor has a sensing face, the sensing face of the second distance sensor being flush with the frontal face of the one ring.

8. The rolling bearing according to claim 5, further comprising a control unit connected to the second distance sensor and adapted to trigger an alarm when a value of the axial distance measured by the second distance sensor is greater than a second predetermined threshold.

9. The rolling bearing according to claim 5, further comprising at least one third distance sensor mounted on the other one of the first and second rings and provided with a sensing face oriented axially outwardly to measure an axial distance between a frontal face of the other one of the first and second rings and a second assembly surface of the machine facing the frontal face of the other ring, the frontal face of the other ring being located axially on a side opposite to the frontal face of the one ring.

10. The rolling bearing according to claim 9, further comprising a control unit connected to the third distance sensor and adapted to trigger an alarm when a value of the axial distance measured by the third distance sensor is greater than a third predetermined threshold.
